(19) United States
(12) Patent Application Publication
(10) Pub. No.: US 2009/0033270 A1
(43) Pub. Date: Feb. 5, 2009

(54) Position Feedback Device for a Motor

(76) Inventors: Hsin-An CHIANG, Taichung (TW); Chia-Chun WEI, Taichung (TW)

Correspondence Address: Dr. BANGER SHIA, 102 Lindencrest Ct., Sugar Land, TX, 77479-5201, US

(21) Appl. No.: 11/833,232

(22) Filed: Aug. 3, 2007

(51) Int. Cl. G05D 3/12

(52) U.S. Cl. 318/640; 318/647; 318/652; 318/670

(57) ABSTRACT

A position feedback device for a motor comprises a driven member and a sensing device. The driven member is indirectly connected to the motor and driven by it. The sensing device detects the travel length of the motor by sensing the driven member. With the method of indirectly sensing the motor, the measurement error, production cost can be reduced, and the assembling position is flexible.

### BACKGROUND OF THE INVENTION

1. Field of the Invention

The present invention relates to a position feedback device for a motor, and more particularly to a position feedback device for a motor, which is capable of indirectly detecting the travel length of the motor.

2. Description of the Prior Art

The basic configuration of a motor is such that a plurality of magnets is disposed on a stator, and then the coil windings of the motor are energized to produce a magnetic field which enables the mover to move with respect to the stator. However, after the power of the motor is cut off, the mover will continue to move a certain distance due to inertia. Hence, for a conventional motor, it is impossible to know the relative position of the mover and the stator, and as a result, when the motor is started next time, it is unable to use the most appropriate and minimum value of power to drive the motor based on the relative position between the mover and the stator. In addition, when the motor is moving a machine, it is unable to know the precise movement distance and the travel length of the machine. This is the biggest disadvantage since the current various industries are striving for precision.

To solve this problem, a feedback system appeared on the market, as disclosed in TW Pat. No. 080204749, which comprises: a power box, a motor, a reduction gear set, a signal feedback device, and a pulling force transmission member. The signal feedback device serves to compare the resistance signal feedback of the linear displacement of the pulling force transmission member with a reference resistance value and uses it to drive the motor to rotate, so that the signal feedback device and the pulling force transmission member are adjusted gradually to be equal to the predetermined reference resistance and the feedback resistance value so as to stop the motor.

However, this feedback system still has some disadvantages as follows:

1) increasing the production cost: the signal feedback system is arranged separately from the motor, it needs more wire circuits and causes the waste of wire.

2) increasing the manufacturing time: the signal feedback system is arranged separately from the motor, it should redesign a circuit, and thus it should take much time to prepare necessary devices for the circuit.

Therefore, another signal feedback device which can be used directly with the motor was developed, and it is called resolver. The resolver is directly connected to the rotary shaft of the motor and is driven by it and serves to produce feedback signal. However, this signal feedback device still has the following disadvantages:

1) increasing the manufacturing time: the complicated circuits and loops of the resolver make it difficult to design and manufacture such a resolver, and relatively increases the manufacturing time.

2) high cost: since it is difficult and time-consuming to produce the resolver, the human cost is relatively high, plus the complicated structure and high defect rate, the production cost of the resolver is high.

The present invention has arisen to mitigate and/or obviate the afore-described disadvantages.

### SUMMARY OF THE INVENTION

The primary objective of the present invention is to provide a position feedback device for a motor, wherein the motor is connected to a driven device, and the position feedback device is connected to the driven device too. With the driven device providing signal to the position feedback device, the travel length of the motor can be detected. Hence, the position feedback device has the advantages of low cost, low measurement error and flexible assembling position.

In addition, the position feedback device further comprises an interconnecting member and a sensing device. The interconnecting member is connected to the driven device, and it can be rotated when the motor drives the driven device to rotate, so that the sensing device can sense the motion of the interconnecting member and detect the travel length of the motor through the sensed motion of the interconnecting member.

The interconnecting member is provided with magnetism, and the sensing device can detect the travel length of the motor by sensing the magnetism change of the interconnecting member.

A plurality of through holes is formed in the interconnecting member, and the sensing device emits light toward the through holes of the interconnecting member and receives it. When the interconnecting moves, the travel length of the motor can be detected by using the sensing device to count the number of times that the light is interrupted by the interconnecting member.

In addition, the interconnecting member can also be connected to the sensing device, when the interconnecting member moves, it can move the sensing device and change its resistance value, so that the sensing device can figure out the travel length of the motor by sensing the change in resistance value.

### BRIEF DESCRIPTION OF THE DRAWINGS

FIG. 1 is a perspective view of a magnetic field change type position feedback device for a motor in accordance with the present invention;

FIG. 2 is a perspective view of a photointerrupter type position feedback device for a motor in accordance with the present invention;

FIG. 3 is a perspective view of a resistance change type position feedback device for a motor in accordance with the present invention; and

FIG. 4 is another angle of view of showing the position feedback device of FIG. 3.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

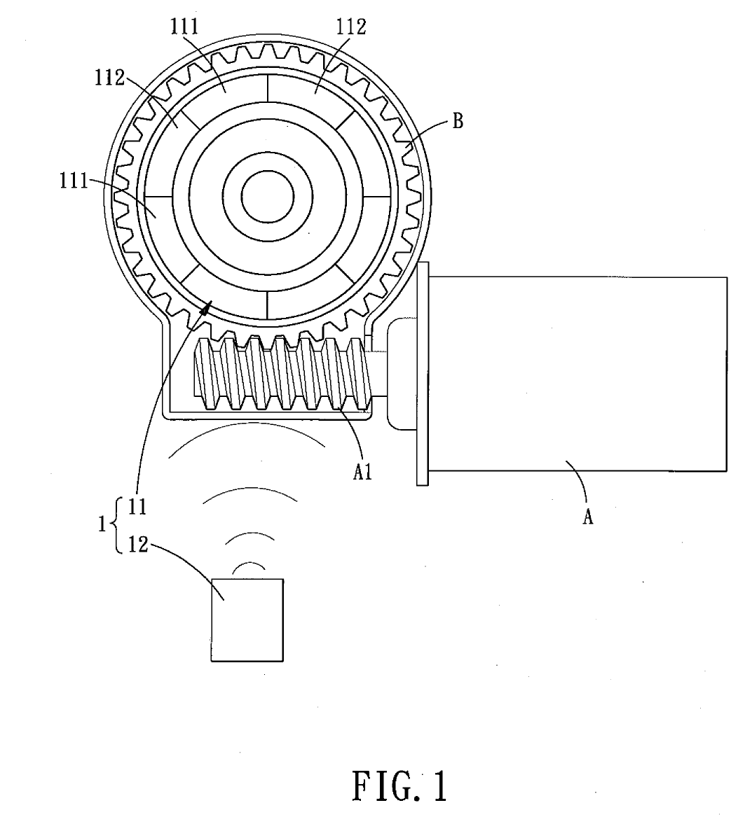

Referring to FIGS. 1-4, a position feedback device 1 for a motor A in accordance with the present invention is a driven device B, and the motor A is connected to the driven device B. The position feedback device 1 comprises an interconnecting member 11 and a sensing device 12.

A first embodiment of the position feedback device for a motor in accordance with the present invention is shown in FIG. 1, a worm A1 is fixed on the rotary shaft of the motor A. The driven device B is a worm wheel to be meshed with the worm A1. The interconnecting member 11 of the position feedback device 1 is an annular structure made of magnets and has four N pole portions and four S pole portions that are arranged alternatively. The interconnecting member 11 is disposed on the driven device B, and the sensing device 12 supplies magnetic force to the interconnecting member 11.

When the motor A rotates, the worm A1 drives the driven device B to rotate, and the interconnecting member 11 rotates simultaneously with the rotation of the driven device B. The sensing device 12 senses the changes of the magnetic field caused by the rotation of the interconnecting member 11 and the displacement of the N pole portions 111 and the S pole portions 112, so that the travel length of the motor A can be figured out based on the number of changes of magnetic field. In this embodiment, the four N pole portions 111 and the four S pole portions 112 divide the interconnecting member 11 equally into eight divisions. Therefore, when the sensing device 12 senses a change in magnetic field, it means that the interconnecting member 11 is rotated 45 degree.

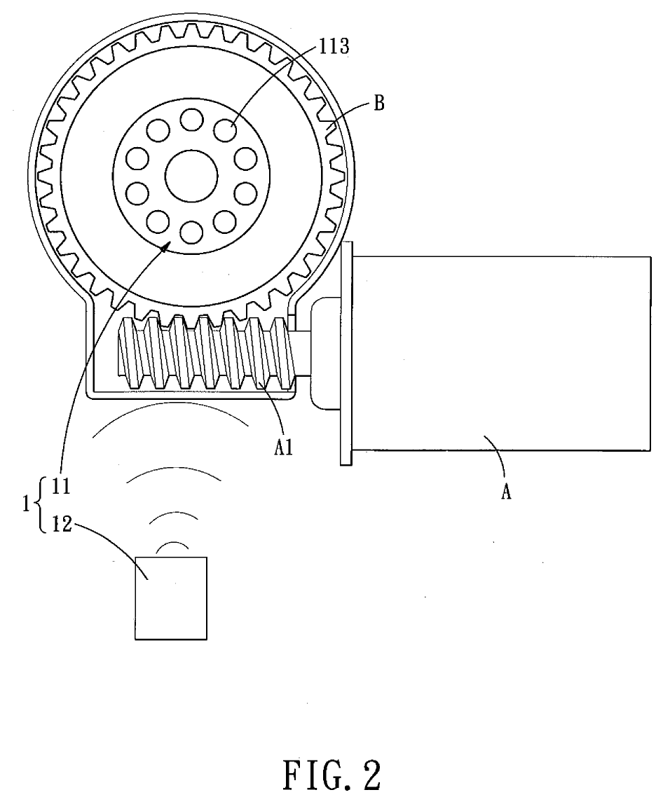

FIG. 2 shows a second embodiment of the position feedback device for a motor in accordance with the present invention, wherein the interconnecting member 11 of the position feedback device 1 is coaxially and interactively connected to the driven device B. In the interconnecting member 11 is formed a plurality of through holes 113 equidistantly located around the rotation axis of the interconnecting member 11, and there are thirteen through holes 113 in this embodiment. The sensing device 12 is a photointerrupter for sensing the interconnecting member 11.

When the driven device B is rotated by the motor A, it will drive the interconnecting member 11 to rotate, and the sensing device 12 will emit light toward the through holes 113 of the interconnecting member 11 and receive it. When the interconnecting member 11 rotates, the through holes 113 will move sequentially to allow for passage of the light emitted from the sensing device 12. Therefore, with using the sensing device 12 to count the number of times that the light is interrupted by the interconnecting member 11 can figure out the travel length of the motor. The interconnecting member 11 in this embodiment has 13 through holes 113. Therefore, if the sensing device 12 senses two times of light interruption, it means that the interconnecting member 11 is rotated 36 degrees.

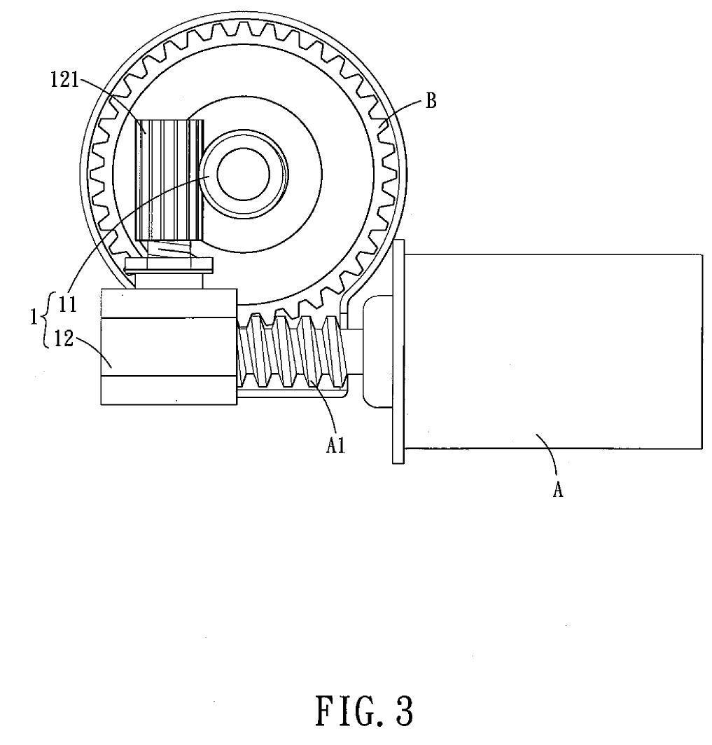

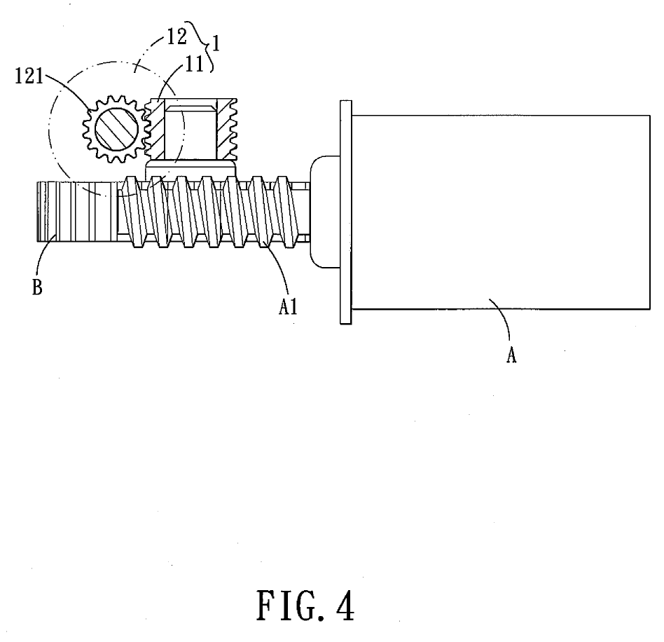

FIGS. 3 and 4 show a third embodiment of the position feedback device for a motor in accordance with the present invention, wherein the interconnecting member 11 of the position feedback device 1 is a worm to be coaxially and interactively connected to the driven device B. The sensing device 12 is a variable resistor with an input end 121. The input end 121 in this embodiment is a plane gear to be meshed with the interconnecting member 11.

When the motor A drives the driven member B and the interconnecting member 11 to rotate simultaneously, the interconnecting member 11 will drive the input end 121 of the sensing device 12 to rotate and change the resistance of the sensing device 12, so that the travel length of the motor can be calculated from the value of the changed resistance.

It is known from the above that the position feedback device 1 is indirectly connected to the motor A to sense the travel length of the motor, and it has the following advantages as compared to the conventional structure:

1, reducing measurement errors: since the position feedback device 1 is indirectly connected to the motor A, as compared to the direct connection manner, the added driven device B can reduce the rotation speed. Therefore, the speed that the position feedback device 1 should detect can be reduced accordingly, and thus the measurement accuracy can be improved.

2, flexible assembling position: since the position feedback device 1 is indirectly connected to the motor A via the driven device B, and the driven member B is not limited to a single element, it can also be a tool, a mechanism or a machine. Hence, the position of the position of the feedback device 1 to be located is flexible, making it convenient and easy to use.

While we have shown and described various embodiments in accordance with the present invention, it is clear to those skilled in the art that further embodiments may be made without departing from the scope of the present invention.

What is claimed is:

1. A position feedback device for a motor being connected to a driven device, the driven device being driven by a motor, and the position feedback device comprising:
an interconnecting member connected to and driven by the driven device; and
a sensing device for sensing the interconnecting member to calculate a travel length of the motor.

2. The position feedback device for a motor as claimed in claim 1, wherein the interconnecting member is provided with magnetism, and the sensing device senses magnetism change of the interconnecting member.

3. The position feedback device for a motor as claimed in claim 2, wherein the interconnecting member is an annular structure made of magnets which include a plurality of N pole portions and S pole portions arranged alternatively.

4. The position feedback device for a motor as claimed in claim 1, wherein a plurality of through holes is formed in the interconnecting member, and the sensing device is a photointerrupter for emitting light toward the through holes of the interconnecting member and receiving it.

5. The position feedback device for a motor as claimed in claim 1, wherein the sensing device is a variable resistor, the sensing device is connected to the interconnecting member, and the motion of the interconnecting member changes the resistance value of the sensing device.
